(19) United States
(12) Patent Application Publication
(10) Pub. No.: US 2018/0249019 A1
(43) Pub. Date: Aug. 30, 2018

(54) DETERMINING WHETHER ALL PROCESSES OF A PRINT/COPY/SCAN JOB HAVE COMPLETED

(71) Applicant: Xerox Corporation, Norwalk, CT (US)

(72) Inventors: Steven OWENS, Penfield, NY (US); Kari Kalevi POYSA, Macedon, NY (US); Kathryn K. Matysek, Fairport, NY (US); Stephen John SYDOROWICZ, Macedon, NY (US)

(21) Appl. No.: 15/445,219

(22) Filed: Feb. 28, 2017

(51) Int. Cl. H04N 1/00; G06K 15/00; H04N 1/34

(52) U.S. Cl. CPC H04N 1/00074; H04N 1/0032; H04N 1/00015; H04N 2201/0094; H04N 1/00424; G06K 15/4025; H04N 1/344; H04N 1/00037

(57) ABSTRACT

What is disclosed is a system and method for determining whether all processes performed by various secondary devices on a print/copy/scan job in a document reproduction environment completed. In one embodiment, a user/customer selects an application services represented by selectable icons displayed on a user interface of a multi-function device. In response to an application service having been selected, a list of process steps is retrieved. The various process steps are to be performed by one or more secondary devices for the selected application service. Then, for each secondary device in the retrieved list, a processor communicates to each secondary device to begin performing its associated process steps and waits until a notification is received from each secondary device that it has completed its various process steps. Upon complete of all process steps by all secondary devices, a notification is communicated to the user/customer that the job completed.

### TECHNICAL FIELD

The present invention is directed to systems and methods for determining whether all processes that need to be performed by various secondary devices on a print/copy/scan job in a document reproduction environment have completed.

### BACKGROUND

In many document reproduction environments which perform print/copy/scan jobs for customers, a customer typically approaches a digital document reproduction device and makes a selection on a user interface for a desired job. The device initiates the job and prints out a bill/invoice for the service performed. In many large document reproduction environments with many secondary devices performing various tasks on a customer's job, the job state of all the various secondary devices performing operations on the job is increasingly difficult to ascertain. Within knowledge of the overall job state in the workflow of the customer's job, an invoice may get printed or the customer's account billed prior to completion of that job. The customer may pay for that service without having realized that the job did not complete. This can lead to confusion and frustration. Thus, it is important to know the state of the entire job prior to billing the customer for having performed that job.

Accordingly, what is needed in this art are systems and methods for determining whether all processes that need to be performed by various secondary devices on a print/copy/scan job in a document reproduction environment have completed.

### BRIEF SUMMARY

What is disclosed is a system and method for determining whether all processes that need to be performed by various secondary devices on a print/copy/scan job in a document reproduction environment have completed. In one embodiment, the method involves a user/customer selecting at least one of a plurality of application services represented by selectable icons displayed on a user interface of a multi-function device. In response to an application service having been selected, a processor retrieves a list of process steps from memory that are to be performed by one or more secondary devices in order for the selected application service to be considered complete. Then, for each secondary device in the retrieved list, a processor communicates to each secondary device to begin performing its associated process steps and waits until a notification is received from each secondary device that it has completed its listed process steps. Upon complete of all process steps by all secondary devices in the retrieved list, a notification is communicated to the user/customer that the job completed. In one embodiment, the notification takes the form of a bill or invoice which includes a cost for having performed the selected application service.

Features and advantages of the above-described method will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 shows an example multi-function document reproduction device;

FIG. 2 shows example secondary devices which dock to the multi-function device of FIG. 1;

FIG. 3 shows a multi-function device in communication with a plurality of secondary devices over a network;

FIG. 4 illustrates a customer making a selection of one of a plurality of iconic representations of different available registered application services displayed on the touchscreen of a user interface;

FIG. 5 shows the multi-function device of FIG. 3 in communication with storage device wherein a plurality of lists of processes are stored;

FIG. 6 is a flow diagram which illustrates one example embodiment of the present method for determining whether all processes performed by various secondary devices on a print/copy/scan job in a document reproduction environment completed; and

FIG. 7 is a flow diagram which is a continuation of the flow diagram of FIG. 6 with flow processing continuing with respect to either node A or node B.

### DETAILED DESCRIPTION

What is disclosed is a system and method for determining whether all processes that need to be performed by various secondary devices on a print/copy/scan job in a document reproduction environment have completed.

### Non-Limiting Definitions

A “print/copy/scan job” or simply “job” refers to a unit of work. Example jobs include scanning, copying, printing, publishing, faxing, emailing, uploading to a network attached device such as an FTP server, executing one or more software applications, to name a few. Each job has various process steps associated with it depending on the requirements for that job.

A “process” or “process steps”, as used herein, is an operation that is to be completed in the performance of a given print/copy/scan job. Various processes include, for example, obtaining a scan of a document, communicating the scanned image to a server over a network, the server communicating the image to other secondary devices, invoking a software application which, in turn, performs various process steps. Within individual processes may reside additional processes to be performed.

A “multi-function device” or simply “MFD”, refers to any of a wide array of devices known in the digital document reproduction arts which includes printers, copiers and other xerographic systems, digital presses, newspaper and magazine publishing systems, and the like. One example multi-function device is the Xerox WorkCentre 78xx Series Color Printer 100 in FIG. 1. The MFD of FIG. 1 includes a user interface (UI) for displaying icons which represent selectable application services that can be performed on a given print/copy/scan job.

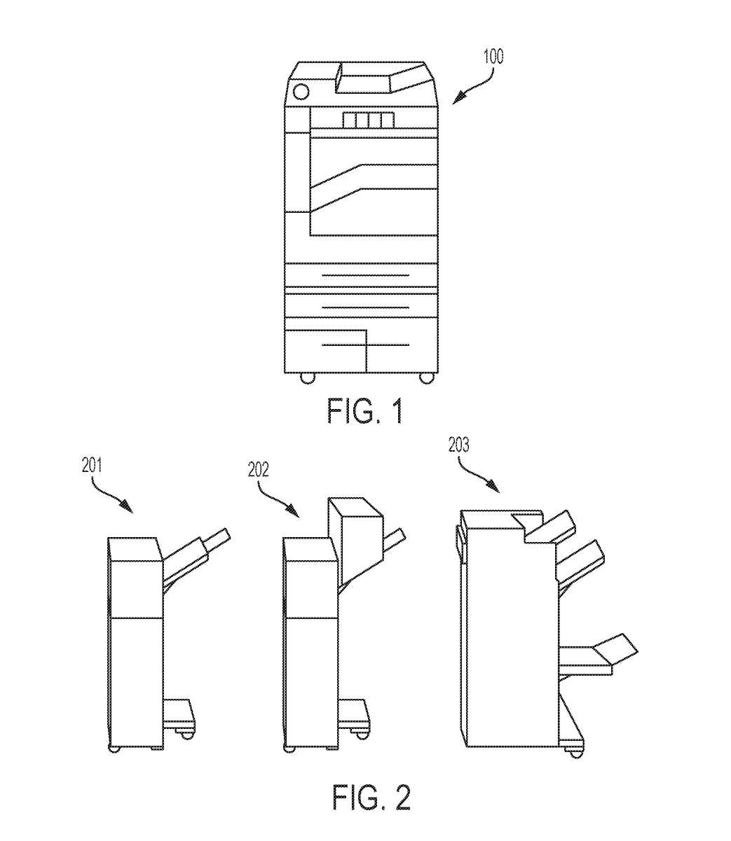

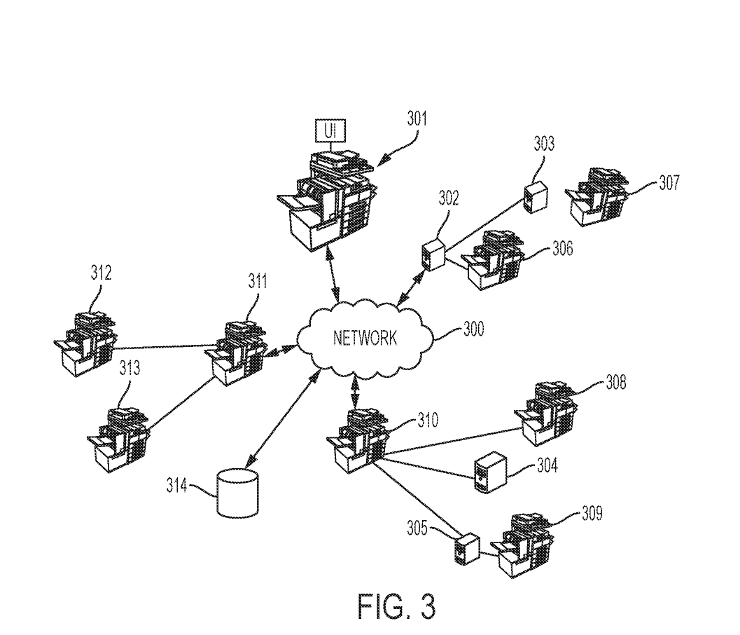

A “secondary device” refers to hardware and/or software which performs one or more process steps on a document for a given print/copy/scan job. The secondary devices of FIG. 2 are the Xerox Office Finisher 201, the Xerox Office Finisher with Booklet Maker 202, and the Xerox Professional Finisher 203 to be used with the WorkCentre of FIG. 1. FIG. 3 shows an example multi-function device 301 in networked communication with a plurality of secondary devices which includes servers 302-304, MFDs 306-313, and networked storage device 314.

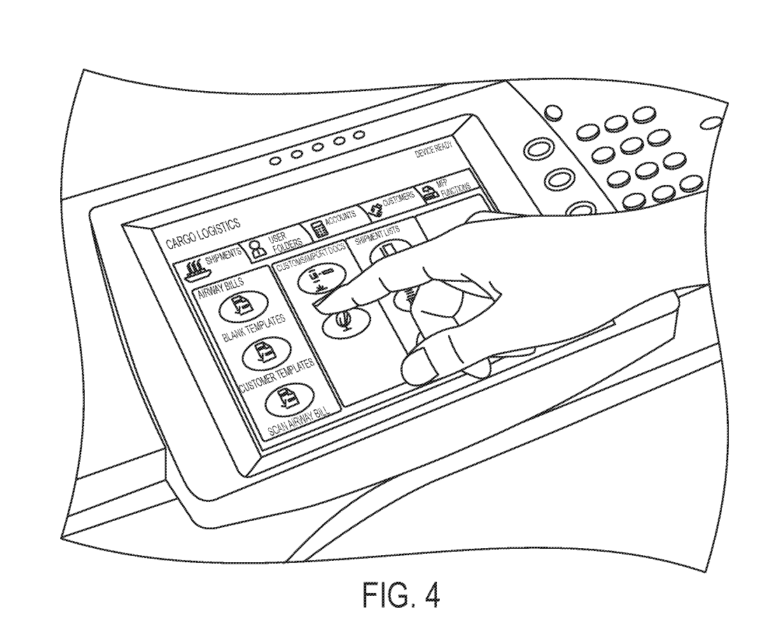

A “selectable icon” refers to a user-selectable software object made selectable through a manipulation of a user interface such as a touchscreen display. FIG. 4 shows a customer making a selection of one of a plurality of icons of different available registered application services designed for a fictitious company called “Cargo Logistics”. For example, the application service labeled “Transport Provider Contracts” is shown with an icon representing a cargo ship. Such a service might, for example, cause the loading of specific forms from a particular paper try, or may provide a copy of any scanned contracts directly to the inbox of a contracts specialist in the legal department. The “Loading Lists” icon is shown with a forklift machine and may perform an inventory service which interacts with a database in a company warehouse. Other icons on the touchscreen display would be associated with custom service applications developed to perform other functions for the company. The specific services being performed by any of the displayed icons will depend on the business solutions that vendors have developed for their client Cargo Logistics. It will be appreciated that selection of any of the service icons may alternatively bring up other pages whereon other icons appear. Under each of the tabs may be one or more icons each for another registered application service. The device's programmable touchscreen display can assume a variety of formats having, for instance, menus, tabs, buttons, icons, and the like, as are widely understood in the computer science arts. Generally, an icon is a small pictogram constructed to provide a user thereof with a visual representation of the software object which the icon is intended to represent. Such icons have one or more property fields which, upon a user selection thereof, are used by an operating system to activate a software function or capability. Selection of an icon initiates the job which begins by retrieving a list of processes to be performed by various secondary devices for the selected application service.

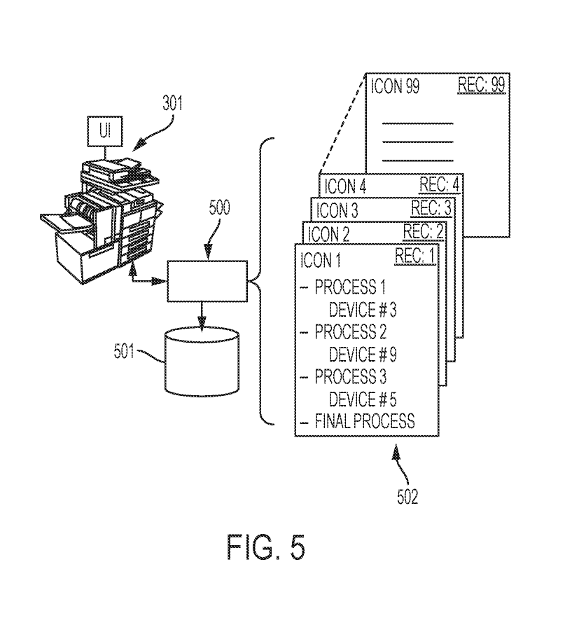

An “application service” or “service application” is a workflow comprising various process steps to be performed by one or more secondary devices in order to complete a given job. In accordance with the teachings hereof, a list of processes is retrieved upon selection of an application service. The list may be retrieved from local storage or from a remote device over a network. A list of processes is shown by way of example in FIG. 5 which shows the MFD 301 of FIG. 3 in communication with a processor 500 external to the MFD which retrieves machine readable program instructions from a storage device 501 which, when executed by the processor, configures the processor to retrieve one or more records from storage device 501 or from a remote device over a network. Each record contains a list of process steps associated with a given job. For example, upon selection of application service icon #1, a first record 502 is retrieved which contains a list of process steps to be performed by secondary devices #3, #5 and #9 which may be, for instance, functions relative to printing, binding and stacking. Secondary device #3 performs process step #1. Secondary device #9 performs process step #2. Secondary device #5 performs process step #3. In this embodiment, the list is an ordered list containing processes to be performed one before another. Although only a single process step is shown associated with a respective secondary device, it should be appreciated that some secondary devices may have a plurality of process steps to perform. FIG. 5 is intended to be illustrative and should not be construed as limiting the scope of the appended claims in any way. Moreover, a “time-to-completion” or “wait-time” may be associated with one or more process steps so that a determination can be made whether a secondary device has failed to respond that it has completed its The processor 500 and the storage device 501 may be internal or external to the MFD.

Assume for explanatory purposes that the customer selected an application service that performs the job of scanning a document using a MFD at one location and transmitting the digital image of that document directly to an intended recipient over a network with a delivery receipt requested. A first process on the retrieved list may be for the MFD to display some text asking the customer to make sure that their copies are placed in the input tray of the MFD so these can be converted to digital images. The customer performs that operation and then, for example, hits a START button. A second listed process may then be to obtain a digital image of the customer's document. A next process may be, for instance, to establish a communication link with a server over the network. A next process would be, for example, to transmit the scanned documents to the intended email recipient. A next process would be to receive a notification from the recipient's email server that the document has been delivered. A next process may then be to store the digital images to a cloud-based storage device (another secondary device). A next process step would be to receive a notification that the storage device has successfully stored the digital images. In one embodiment, the list includes one final process step which is to be executed by a processor upon completion of all other process steps in the retrieved list. An example final process step would be to print a bill for the customer or directly invoice the customer's account.

It should be appreciated that the various different processes to be performed on a given job in response to a customer having selected a desired application service will necessarily depend on the service selected. As such, a discussion as to any specific processes needed for a particular job is discussed herein by way of example. System administrators will decide which processes are to be listed for their respective installed service applications in their own document reproduction environments wherein the teachings hereof find their intended uses.

### Example Flow Diagram

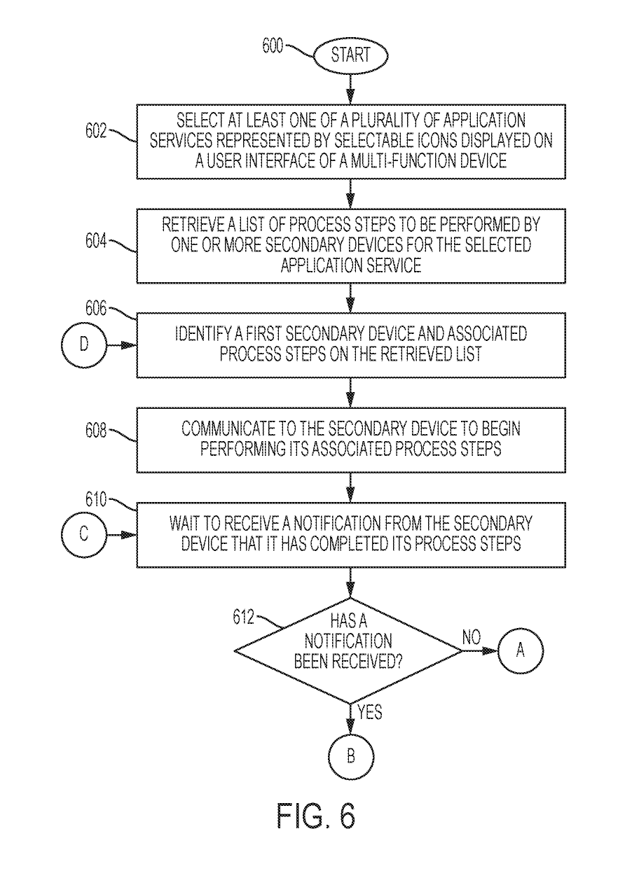

Reference is now being made to the flow diagram of FIG. 6 which illustrates one example embodiment of the present method for determining whether all processes performed by various secondary devices on a print/copy/scan job in a document reproduction environment completed. Flow processing begins at step 600 and immediately proceeds to step 602.

At step 602, select at least one of a plurality of application services represented by selectable icons displayed on a user interface of a multi-function device. One embodiment of a user/customer making a selection of one of a plurality of displayed icons is shown and discussed with respect to FIG. 4.

At step 604, retrieve a list of process steps to be performed by one or more secondary devices for the selected application service. An example list of process steps is shown and discussed with respect to FIG. 5.

At step 506, identify a first secondary device and associated process steps on the retrieved list.

At step 508, communicate to the secondary device to begin performing its associated process steps.

At step 510, a determination is made whether a notification has been received from this secondary device that it has completed its process steps. If the notification has not been received then processing continues with respect to node A. Otherwise, processing continues with respect to node B.

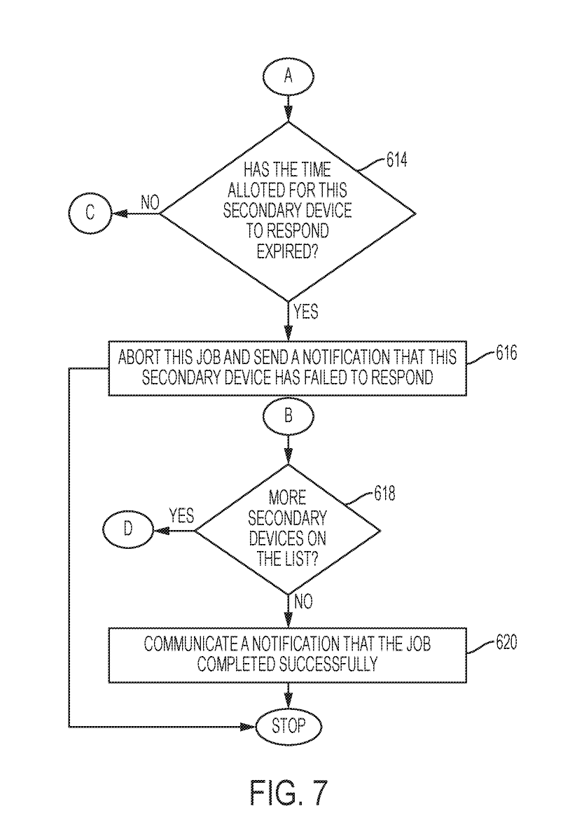

Reference is now being made to the flow diagram of FIG. 7 which is a continuation of the flow diagram of FIG. 6 with flow processing continuing with respect to either node A or node B.

If a notification has not been received then processing continues with respect to node A wherein, at step 612, a determination is made whether the time allotted for this secondary device to respond has expired. If not then processing repeats with respect to node C wherein, at step 610, the processor waits to receive a notification from the secondary device and keeps checking to determine whether the allotted time has expired. After waiting the allotted time, it can be determined that the secondary device has not sent its notification because it is either no longer in communication with the processor or the secondary device has somehow failed to complete one or more of its intended process steps. Thereafter, at step 614, abort this job and send a notification that this secondary device has filed to respond. Thereafter, further processing stops. The notification may be communicated directly to a service technician. Thereafter, additional actions would be taken in response to the notification to determine why the customer's job did not complete. If the notification is received before the expiration of the allotted time, then processing continues with respect to step 616.

At step 616, a determination is made whether another secondary device is on retrieved list. If so then processing continues with respect to node D wherein, at step 606, a next secondary device with associated process steps on the list is identified. Processing repeats in a similar manner until all secondary devices on the list have completed all their respective process steps and the job has completed.

At step 614, communicate a notification that the job completed. In this embodiment, further processing stops. In another embodiment, the notification includes a cost for having performed the selected application service for the customer. In various embodiments hereof, the notification can take the form of a text message, an email, a phone call, or a video. The notification may take the form of a message displayed on a display device or an alert sound activated at, for example, a control panel or cash register. The notification may take the form of a colored or blinking light to provide a visible indication about the status of the job for the visually impaired or a sound being activated for the hearing impaired. The notification may be communicated to one or more remote devices over a wired or wireless network or sent directly to a handheld wireless cellular device of the customer or a service technician.

The flow diagrams depicted herein are illustrative. One or more of the operations may be performed in a differing order. Other operations may be added, modified, enhanced, or consolidated. Variations thereof are intended to fall within the scope of the appended claims.

It is contemplated that one or more aspects of the present method may be implemented on a dedicated computer system or workstation, and may also be practiced in distributed computing environments where tasks are performed by remote processing devices that are linked through a communication network. The teachings hereof can be implemented in hardware or software using any known or later developed systems, structures, devices, and/or software by those skilled in the applicable art without undue experimentation from the functional description provided herein with a general knowledge of the relevant arts. Various modules may designate one or more components which may, in turn, comprise software and/or hardware designed to perform the intended function. One or more aspects of the methods described herein are intended to be incorporated in an article of manufacture which may be shipped, sold, leased, or otherwise provided separately either alone or as part of a product suite or a service.

It will be appreciated that the above-disclosed and other features and functions, or alternatives thereof, may be desirably combined into other different systems or applications. Presently unforeseen or unanticipated alternatives, modifications, variations, or improvements may become apparent and/or subsequently made by those skilled in this art which are also intended to be encompassed by the following claims.

What is claimed is:

1. A computer implemented method for determining whether all processes performed by various secondary devices on a customer's print/copy/scan job have completed, the computer implemented method comprising:
selecting at least one of a plurality of application services represented by selectable icons displayed on a user interface of a multi-function device;
retrieving, from a computer memory, at least one record containing at least
a list of process steps to be performed by one or more secondary devices for the selected application service in order for the selected application service to be considered complete,
a respective time-to-completion during which the secondary device performing the list of process steps must respond with a notification that the secondary device has completed each of the process steps in the list of process steps, and
at least one final process to be performed upon completion of all other process steps in the list of process steps;
communicating to the secondary devices to begin performing their process steps;
receiving, from each secondary device performing their process steps in the retrieved list of process steps, a notification that the secondary device has completed its process steps, and repeating in response to not having received the notification from the secondary device within each process steps respective time-to-completion;
in response to all process steps being completed, performing the at least one final process listed in the retrieved list;
in response to completion of the at least one final process, communicating a notification to that the job completed; and
in response to any process steps not being completed by any of the secondary devices within each time-to-completion, aborting further processing of this job and communicating to at least one of a user, the customer, a system administrator, and a service technician, that this job did not complete.

2. (canceled)

3. The method of claim 1, further comprising using a scanning device of the multi-function device to obtain a digital image thereof, the application service being performed on the digital image.

4-5. (canceled)

6. The method of claim 1, wherein, in response to at least one of the secondary devices not completing their process steps in the respective time-to-completion, further communicating that the at least one of the secondary devices failed to respond.

7. (canceled)

8. The method of claim 1, wherein the communication includes any of: a cost for having performed the selected application service for the customer, an error report, a diagnostic, and a delivery confirmation.

9. A system for determining whether all processes performed by various secondary devices on a customer's print/copy/scan job have completed, the system comprising:
a multi-function device;
at least one secondary device; and
display selectable icons a user interface of the multi-function device, each icon representing an application service;
receive a user selection of at least one of the displayed icons;
retrieve, from a memory, at least one record containing at least a list of process steps to be performed by one or more secondary devices for the selected application service in order for the selected application service to be considered complete, a respective time-to-completion during which the secondary device performing the list of process steps must respond with a notification that the secondary device has completed each of the steps in the list of process steps, and at least one final process to be performed upon completion of all other process steps in the list of process steps;
communicate to the secondary devices to begin performing their process steps;
receive a notification from each secondary device performing their process steps in the list of process steps, that the secondary device have completed its process steps, and repeating in response to not having received the notification from the secondary device within each process steps respective time-to-completion;
in response to all process steps being completed, performing the at least one final process listed in the retrieved list;
in response to completion of the at least one final process, communicate to the customer that the job completed; and
in response to any process steps not being completed by any of the secondary devices within each time-to-completion, abort further processing of this job and communicate to at least one of a user, the customer, a system administrator, and a service technician, that this job did not complete.

10. (canceled)

11. The system of claim 9, further comprising the multi-function device receiving a digital image, the application service being performed on the digital image.

12-13. (canceled)

14. The system of claim 9, wherein, in response to at least one of the secondary devices not completing their process steps in the respective time-to-completion, further communicate that the at least one secondary device failed to respond.

15. (canceled)

16. The system of claim 9, wherein the communication includes any of: a cost for having performed the selected application service for the customer, an error report, a diagnostic, and a delivery confirmation.

17. The system of claim 9, wherein the secondary device is external to the multi-function device.

18. The system of claim 9, wherein the communication takes the form of any of: a message displayed on a display device, an alert activated a control panel, an alert activated at a cash register.

19. The system of claim 9, further comprising creating an invoice base on each of the process steps that have completed in the retrieved list of process steps.

20. The method of claim 1, wherein the communication takes the form of any of: a message displayed on a display device, an alert activated a control panel, an alert activated at a cash register.

21. The method of claim 1, wherein creating an invoice base on each of the process steps that have completed in the retrieved list of process steps.
